(19) United States
(12) Patent Application Publication
(10) Pub. No.: US 2009/0265515 A1
(43) Pub. Date: Oct. 22, 2009

(54) Information Processing Apparatus, Information Processing Method, and Computer Program

(76) Inventor: Hiroshi KYUSOJIN, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/419,817

(22) Filed: Apr. 7, 2009

(30) Foreign Application Priority Data
Apr. 16, 2008 (JP) P2008-106354

(51) Int. Cl. G06F 15/76; G06F 9/06; G06F 12/00

(52) U.S. Cl. 711/154; 712/34; 712/E09.003; 710/22; 711/E12.001

(57) ABSTRACT

An information processing apparatus having a multi-processor unit including a plurality of processors. The multi-processor unit includes: a main-processor element including a main processor; and at least one sub-processor element having a sub-processor, a local memory corresponding to each of the processors, and a memory flow controller (MFC) executing data input from and data output to the local memory by DMA (Direct Memory Access), wherein the memory flow controller (MFC) inputs data from the outside of the multi-processor unit, stores the data into the local memory by DMA processing, and further outputs the data stored in the local memory to an external memory of the multi-processor unit or a device by DMA processing.

### CROSS REFERENCES TO RELATED APPLICATIONS

The present invention contains subject matter related to Japanese Patent Application JP 2008-106354 filed in the Japanese Patent Office on Apr. 16, 2008, the entire contents of which are incorporated herein by reference.

### BACKGROUND OF THE INVENTION

1. Field of the Invention

The present invention relates to an information processing apparatus, an information processing method, and a computer program. More particularly, the present invention relates to an information processing apparatus, an information processing method, and a computer program which perform data transfer processing or copy processing in the apparatus.

2. Description of the Related Art

In an information processing apparatus performing various kinds of data processing, in order for an application executed on the information processing apparatus to process data held by a device performing, for example, communication processing or various kinds of data processing, it becomes necessary to move or copy the data to a memory space (user space) which can be accessed by the application.

A description will be given of a general processing flow when data on a device is passed to an application with reference to FIG. 1. In an information processing apparatus 100 shown in FIG. 1, a CPU 110, a device 120, such as a communication device, a data processing device, etc., and a memory 130 are connected to a system bus 102. Data transfer is performed among individual components connected to the system bus 102 through the system bus 102.

The memory 130 has a kernel space 132 managed by an OS (Operating System) and a user space 131 accessible by various applications performed under the control of the CPU 110.

Data 121 in the device 120 is first transferred to the kernel space 132 in the memory 130 using DMA (Direct Memory Access). Next, the data transferred to the kernel space 132 is copied to the user space 131 under the control of the OS executed by the CPU (Central Processing Unit).

By performing such steps, that is to say, by performing data transfer and copy processing from the device to the kernel space and then to the user space, it is possible to move data to the user space 131 which is accessible by an application.

A description will be given of the processing flow with reference to a flowchart shown in FIG. 2. First, in step S101, the device obtains data. Next, in step S102, the device transfers the data to the kernel space in the memory using DMA (Direct Memory Access). Next, in step S103, the data is copied to the user space under the control of the OS executed by the CPU (Central Processing Unit). Finally, in step S104, the application obtains the data from the user space.

In this manner, in order to store the data held by the device into the user space available for an application, it becomes necessary to perform a plurality of processing steps. That is to say, it becomes necessary to execute many processing cycles, and thereby transfer cost is increased and data processing efficiency is decreased. In order to address such a problem, various methods have been proposed in order to reduce transfer cost between the device and the memory. For example, a method of dividing DMA transactions, or a method of integrating the transactions, further a method of setting not to use DMA depending on conditions, and the like, have been proposed.

For example, Japanese Patent No. 2664838 (IBM) has disclosed a configuration in which packet structure information is transmitted at the same time with data, DMA destination is changed for each packet component, and thus data division and copying in a receiving terminal is prevented in order to improve processing efficiency.

Also, Japanese Unexamined Patent Application Publication No. 2000-112849 (Hitachi Ltd.) has disclosed a configuration in which discontinuous data in a real memory space is allowed to be handled as a continuous area using an address conversion table, a plurality of times of DMA processing are put together into one time, and thus processing is speeded up by the reduction of the number of times of DMA processing.

Further, Japanese Unexamined Patent Application Publication No. 9-288631 (Hitachi Ltd.) has proposed a configuration, in which when data is copied from a device to a host, a method of copying is changed depending on a length of the data to be copied. Specifically, a configuration, in which DMA or PIO (Programmed I/O) is selectively used in accordance with the length of the data in order to optimize copy performance, has been disclosed.

Also, in recent years, with the advent of a high-speed serial bus, such as PCI-Express, high-speed processing has become possible in DMA itself from a device to a memory. However, copy processing of data, which has been transferred from a device to a kernel space by DMA, and to a user space for allowing an application to handle the data, that is to say, the copy processing of data from a kernel space to a user space depends on a processing performance of a CPU. As a result, in a configuration in which a related-art transfer sequence, namely data transfer from the device to the kernel space and then to the user space is performed, processing efficiency is difficult to be increased unless processing performance of the CPU is increased.

In order to address such a problem, a method of reducing processing cost by zero copy, in which DMA is not performed to a kernel space, but is performed directly to a user space, has been proposed.

Japanese Unexamined Patent Application Publication No. 9-294132 (Hitachi Cable, Ltd.) has proposed a configuration of a frame relay apparatus. In the configuration, a method of managing memory, which allows the frame relay apparatus to handle a received frame as a transmission frame without copying the received frame into a memory. By this configuration, relaying frames independently of memory copy performance has been achieved.

Also, in Japanese Unexamined Patent Application Publication No. 2006-302246 (Fujitsu Limited), a scheme in which data received by a device is directly passed to a user space (application) by controlling a DMA destination of that data is achieved.

A description will be given of a method of zero copy with reference to FIG. 3. FIG. 3 illustrates an information processing apparatus 140 having the same configuration as that shown in FIG. 1. The information processing apparatus 140 has a configuration in which a CPU 150, a device 160, such as a communication device, a data processing device, etc., and a memory 170 are connected to a system bus 142. Data transfer is performed among individual components connected to the system bus 142 through the system bus 142.

The memory 170 has a kernel space 172 managed by an OS (Operating System) and a user space 171 accessible by various applications performed under the control of the CPU 150.

In the configuration to which the method of zero copy is applied, data 161 in the device 160 is copied to a user space 171 in the memory 170 using DMA (Direct Memory Access). That is to say, the data 161 is not copied to the kernel space 172, but is copied to the user space 171. In this manner, it becomes possible to reduce processing cost by zero copy, which is directly performed on the user space.

However, in order to perform such zero copy, it becomes necessary to change an entire system including, for example a device driver, an application, etc. In addition, a separation of a kernel space and a user space becomes obscure, and thus this portion might become a security hole. Thereby, robustness of the system might be impaired.

### SUMMARY OF THE INVENTION

The present invention has been made in view of the above-described problems. It is desirable to provide an information processing apparatus, an information processing method, and a computer program which efficiently perform data transfer processing or copy processing in the apparatus in order to achieve efficient and high-speed data processing.

According to an embodiment of the present invention, there is provided an information processing apparatus having a multi-processor unit including a plurality of processors, the multi-processor unit including: a main-processor element including a main processor; and at least one sub-processor element having a sub-processor, a local memory corresponding to each of the processors, and a memory flow controller (MFC) executing data input from and data output to the local memory by DMA (Direct Memory Access), wherein the memory flow controller (MFC) inputs data from the outside of the multi-processor unit, stores the data into the local memory by DMA processing, and further outputs the data stored in the local memory to an external memory of the multi-processor unit or a device by DMA processing.

Further, the information processing apparatus according to the embodiment of the present invention further includes a system memory being bus-connected to the multi-processor unit, wherein the system memory may be a memory in which a kernel space managed by an operating system (OS) and a user space allowed to be used by an application are defined, and the memory flow controller (MFC) may input data from the kernel space of the system memory and may store the data into the local memory by DMA processing, and may perform processing of outputting the data stored in the local memory to the user space of the system memory by DMA processing.

Further, the information processing apparatus according to the embodiment of the present invention further includes: a first device and a second device which are bus-connected to the multi-processor unit, wherein the memory flow controller (MFC) may input data from the first device by DMA processing and stores the data into the local memory, and may further output the data stored in the local memory to the second device by DMA processing.

Further, in the information processing apparatus according to the embodiment of the present invention, the sub-processor element having the memory flow controller (MFC) executing data transfer by the DMA processing may be an element executing the operating system (OS).

Further, in the information processing apparatus according to the embodiment of the present invention, the data output to the user space through data transfer by the DMA processing may be obtained and used by the application executed by any one of the plurality of sub-processor elements in the multi-processor unit.

Moreover, according to another embodiment of the present invention, there is provided a method of processing information for performing data transfer processing in an information processing apparatus, the information processing apparatus having a multi-processor unit including a plurality of processors, the multi-processor unit including: a main-processor element including a main processor; and at least one sub-processor element having a sub-processor, a local memory corresponding to each of the processors, and a memory flow controller (MFC) executing data input from and data output to the local memory by DMA (Direct Memory Access), the method including the steps of: the memory flow controller (MFC) inputting data from the outside of the multi-processor unit, storing the data into the local memory by DMA processing, and the memory flow controller (MFC) performing output processing of the data stored in the local memory to an external memory of the multi-processor unit or a device by DMA processing.

Moreover, according to another embodiment of the present invention, there is provided a computer program for causing an information processing apparatus to perform data transfer processing, the information processing apparatus having a multi-processor unit including a plurality of processors, the multi-processor unit including: a main-processor element including a main processor; and at least one sub-processor element having a sub-processor, a local memory corresponding to each of the processors, and a memory flow controller (MFC) executing data input from and data output to the local memory by DMA (Direct Memory Access), the method including the steps of: the memory flow controller (MFC) inputting data from the outside of the multi-processor unit, storing the data into the local memory by DMA processing, and the memory flow controller (MFC) performing output processing of the data stored in the local memory to an external memory of the multi-processor unit or a device by DMA processing.

In this regard, a program according to the present invention is a computer program capable of being provided through a storage medium and a communication medium in a computer readable format, for example, to a general-purpose computer system capable of performing various kinds of program code. By providing such a program in a computer readable format, the processing in accordance with the program is performed on a computer system.

Other and further objects, features and advantages of the present invention will become apparent by the detailed description based on the following embodiments of the present invention and the accompanying drawings. In this regard, in this specification, a system is a logical set of a plurality of apparatuses, and is not limited to a set of constituent apparatuses that are contained in a same casing.

By a configuration according to an embodiment of the present invention, at the time of data copy processing between a kernel space of a system memory and a user space in an information processing apparatus, and data transfer processing between devices, data transfer and copy processing is performed by a memory flow controller (MFC) disposed in a sub-processor unit in a multi-processor unit transferring data from outside to a local memory of the sub-processor unit, and then DMA-transferring the data from the local memory to an external memory or a device. With this configuration, data transfer and copy processing is achieved without imposing load on the main processor.

### BRIEF DESCRIPTION OF THE DRAWINGS

FIG. 1 is a diagram illustrating an example of data transfer processing in an information processing apparatus;

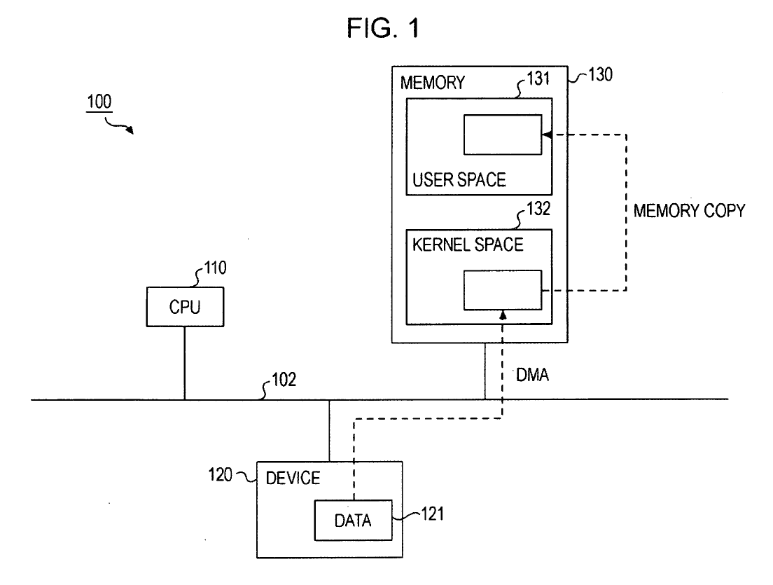

FIG. 2 is a flowchart illustrating a data transfer processing sequence in an information processing apparatus;

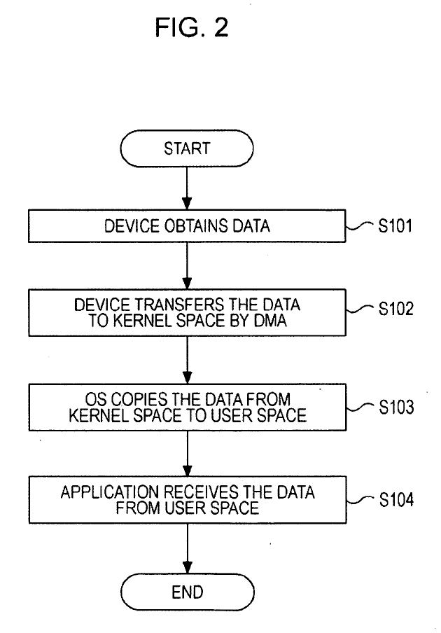

FIG. 3 is a diagram illustrating an example of processing to which zero copy is applied as an example of data transfer processing in an information processing apparatus;

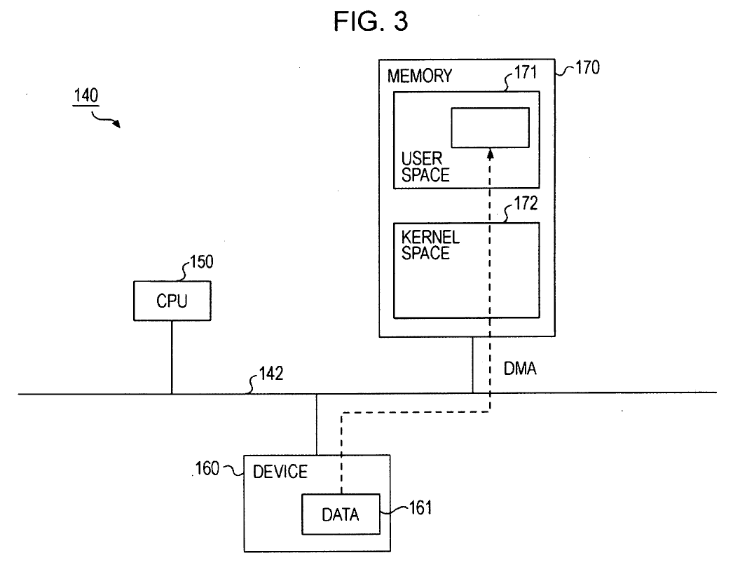

FIG. 4 is a diagram illustrating an example of data transfer processing in an information processing apparatus according to an embodiment of the present invention;

FIG. 5 is a flowchart illustrating a data transfer processing sequence in an information processing apparatus according to an embodiment of the present invention;

FIG. 6 is a diagram illustrating an example of data transfer processing in an information processing apparatus according to an embodiment of the present invention; and

FIG. 7 is a flowchart illustrating a data transfer processing sequence in an information processing apparatus according to an embodiment of the present invention.

### DESCRIPTION OF THE PREFERRED EMBODIMENTS

In the following, a detailed description will be given of an information processing apparatus, an information processing method, and a computer program according to embodiments of the present invention.

### First Embodiment

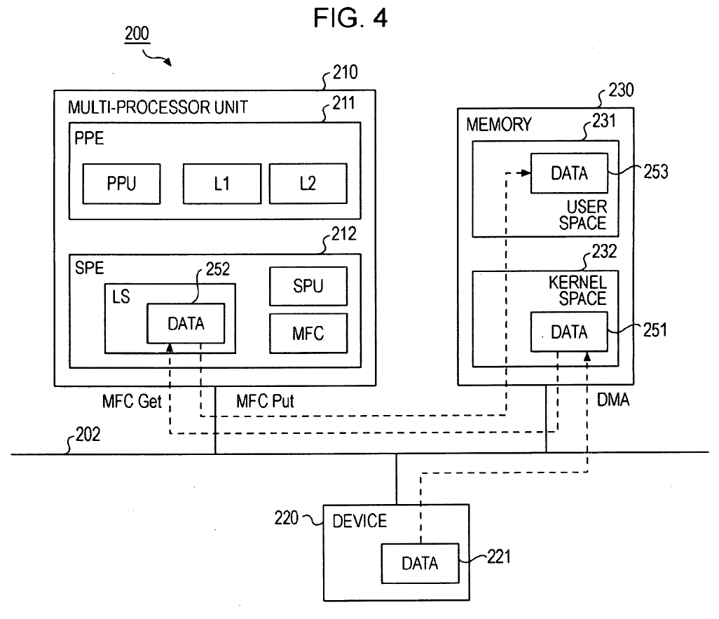

First, a description will be given of a configuration of an information processing apparatus according to an embodiment of the present invention and an example of processing with reference to FIG. 4. An information processing apparatus 200, illustrated in FIG. 4, according to the present embodiment has a configuration in which a multi-processor unit 210, a device 220 including a communication device, such as a network card, etc., data processing device, such as a video card, etc., and a memory 230 as a system memory are connected to a system bus 202. Data transfer is performed among individual constituent parts connected to the system bus 202 through the system bus 202.

The memory 230 has a kernel space 232 managed by an OS (Operating System) and a user space 231 accessible from various applications executed under the control of a processor element of the multi-processor unit 210.

The multi-processor unit 210 has a PPE (Power Processor Element) 211, which is an element including a main processor (PPU) and an SPE (Synergistic Processor Element) 212, which is an element including a sub-processor (SPU).

The multi-processor unit 210 includes one main-processor element (PPE) 211 and a plurality of, for example eight sub-processor elements (SPE) 212. The plurality of processor elements included in the multi-processor unit 210 can perform data processing in parallel. In this regard, in the multi-processor unit 210 in FIG. 4, only one sub-processor element (SPE) 212 is shown. However, there are a plurality of sub-processor elements (SPE) having the same configuration.

The main-processor element (PPE) 211 has a PPU (Power Processor Unit), an L1 cache (Level-1 cache), and an L2 cache (Level-2 cache).

The sub-processor elements (SPE) 212 has an SPU (Synergistic Processor Unit), which is a general-purpose SIMD (Single Instruction stream Multiple Data stream) arithmetic unit, a local memory corresponding to each SPU called a 256-KB local store (LS), and a memory flow controller (MFC), which is a DMA controller.

The MFC of the SPE 212 has a function of DMA-transferring data between a constituent part of the information processing apparatus and a local store (LS) in the SPE 212. For example, the MFC performs DMA data transfer between the memory 230 in the system and the local store (LS) in the SPE 212.

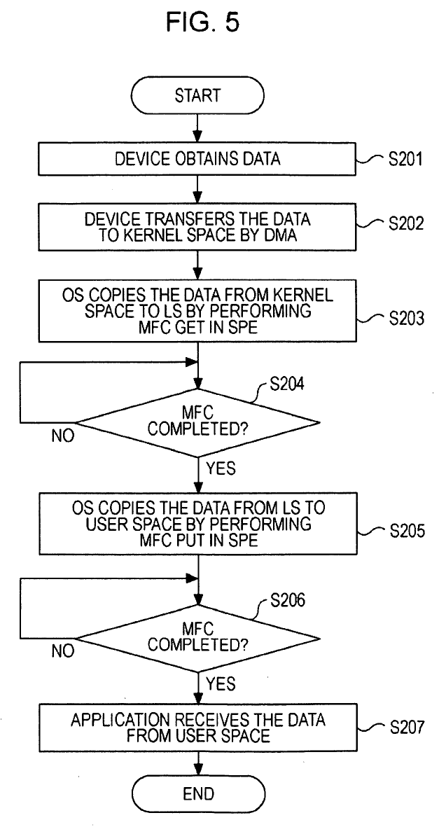

With reference to a flowchart shown in FIG. 5, a description will be given of a processing sequence for storing data 221 held by the device 220 into the user space 231 in the memory 230 in the present embodiment.

First, in step S201, the device 220 shown in FIG. 4 obtains the data 221.

Next, in step S202, the device 220 transfers the data into the kernel space 232 of the memory 230 using DMA (Direct Memory Access).

Next, in step S203, the data 251 in the kernel space 232 is copied to the local store (LS) of the sub-processor element (SPE) 212 under the control of an OS executed by a sub-processor element (SPE) 212 in the multi-processor unit 210. The data 251 shown in FIG. 4 is copied to data 252. This data copy processing is executed as data copy processing (MFC GET) by the MFC of the sub-processor element (SPE) 212.

Next, in step S204, a determination is made of whether the MFC processing has been completed. That is to say, a determination is made on whether the data 251 in the kernel space 232 has all been copied to the local store (LS) of the sub-processor element (SPE) 212. In this regard, one-time data copy processing by the MFC has an upper limit (for example, 16 KB) on the amount of data that can be copied. The copy processing is performed repeatedly in accordance with the size of the data to be copied.

When all the data 251 in the kernel space 232 has been copied to the local store (LS) of the sub-processor element (SPE) 212, the MFC processing is determined to have been completed in step S204. As shown in FIG. 4, the data 252 is stored into the local store (LS) of the sub-processor element (SPE) 212.

Next, the processing proceeds to step S205, and the data 252 stored in the local store (LS) is copied to the user space 231 of the memory 230 under the control of the OS executed by the sub-processor element (SPE) 212. This is data 253 shown in FIG. 4. This copy processing is performed as data copy processing (MFC PUT) by the MFC of the sub-processor element (SPE) 212.

In the data copy processing by the MFC, one-time data copy processing by the MFC has also an upper limit (for example, 16 KB) on the amount of data that can be copied. Thus, the copy processing is performed repeatedly in accordance with the size of the data to be copied.

When all the data 252 stored in the local store (LS) has been copied to the user space 231 in the memory 230, the MFC processing is determined to have been completed in step S206. As shown in FIG. 4, the data 253 is stored into the user space 231 in the memory 230.

Finally, in step S207, an application obtains the data 253 from the user space 231 in the memory 230. In this regard, the application is executed by any one of the plurality of the sub-processor elements (SPE) included in the multi-processor unit 210, for example.

In this manner, in the present embodiment, the following processing is performed in order to store data held by the device into a user space available to an application.

(1) Execution of direct memory access (DMA) by the MFC of the sub-processor elements (SPE), that is to say, execution of MFC GET.

By this processing, data in the kernel space of the memory is copied to the local store (LS) of the sub-processor element (SPE).

(2) Execution of direct memory access (DMA) by the MFC of the sub-processor elements (SPE), that is to say, execution of MFC GET.

By this processing, the data in the local store (LS) of the sub-processor element (SPE) is copied to a user space of the memory.

By performing the processing sequence, data copy is achieved from the kernel space to the user space without an occurrence of processing load on the main processor, the PPE 211.

In this regard, the example of processing described with reference to FIGS. 4 and 5 is an example of data copy processing performed between the kernel space and the user space. However, the processing according to the present invention is not limited to such processing, and can be applied to memory copy within the kernel space and within the user space. That is to say, the data copy within a same space can be performed by data copy processing through the local store (LS) of a sub-processor element.

### Second Embodiment

The data copy processing by the MFC of the sub-processor element is not limited to the copy processing with a main memory like the memory 230 shown in FIG. 4. For example, the data copy processing can be applied to the data copy between devices, for example.

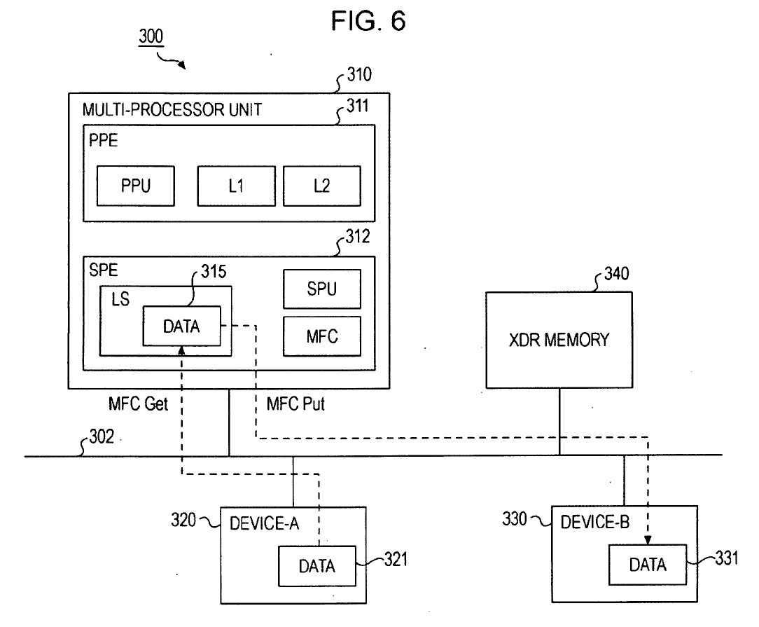

A description will be given of an example of data transfer processing between devices with reference to FIG. 6. An information processing apparatus 300 illustrated in FIG. 6 has a configuration in which a multi-processor unit 310, a device-A 320 and a device-B 330, such as a communication device, data processing device, etc., and a memory 340 are connected to a system bus 302. Data transfer is performed among individual constituent parts connected to the system bus 302 through the system bus 302.

The multi-processor unit 310 has a same configuration as the configuration described with reference to FIG. 4 before. That is to say, the multi-processor unit 310 has a PPE (Power Processor Element) 311, which is an element including a main processor (PPU), and an SPE (Synergistic Processor Element) 312, which is an element including a sub-processor (SPU).

The multi-processor unit 310 includes one main-processor element (PPE) 311 and a plurality of, for example eight, sub-processor elements (SPE) 312. In this regard, in the multi-processor unit 310 in FIG. 6, only one sub-processor element (SPE) 312 is shown. However, there are a plurality of sub-processor elements (SPE) having the same configuration.

The main-processor element (PPE) 311 has a PPU (Power Processor Unit), an L1 cache (Level-1 cache), and an L2 cache (Level-2 cache).

The sub-processor elements (SPE) 312 includes an SPU (Synergistic Processor Unit), which is a general-purpose SIMD (Single Instruction stream Multiple Data stream) arithmetic unit, a local memory corresponding to each SPU called a 256-KB local store (LS), and a memory flow controller (MFC), which is a DMA controller.

The MFC of the SPE 312 has a function of DMA-transferring data between a constituent part of the information processing apparatus and a local store (LS) in the SPE 312. For example, the MFC has a function of DMA data transfer between the device-A 320, the device-B 330 in the system and the local store (LS) in the SPE 312.

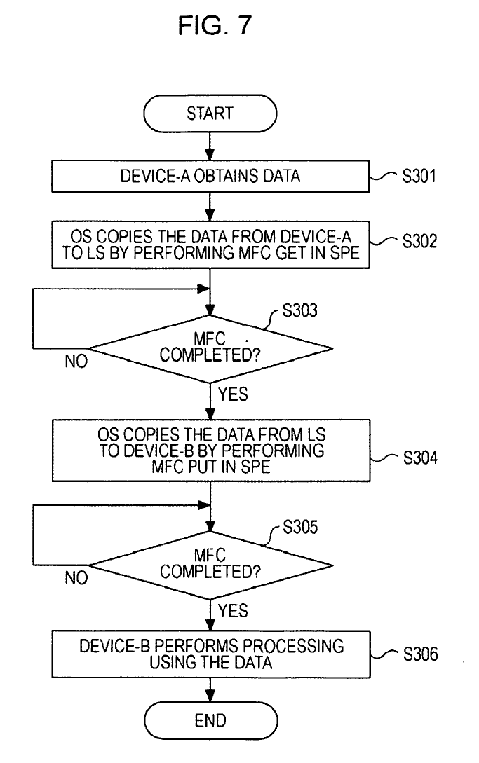

With reference to a flowchart shown in FIG. 7, a description will be given of a processing sequence for transferring data 321 held by the device-A 320 to the device-B 330 in the present embodiment.

First, in step S301, the device-A 320 shown in FIG. 6 obtains the data 321.

Next, in step S302, the data 321 in the device-A 320 is copied to the local store (LS) of the sub-processor element (SPE) 312 under the control of an OS executed by a sub-processor element (SPE) 312 in the multi-processor unit 310. The data 321 shown in FIG. 6 is copied to data 315. This data copy processing is executed as data copy processing (MFC GET) by the MFC of the sub-processor element (SPE) 312.

Next, in step S303, a determination is made of whether the MFC processing has been completed. That is to say, a determination is made on whether the data 321 in the device-A 320 has all been copied to the local store (LS) of the sub-processor element (SPE) 312. In this regard, one-time data copy processing by the MFC has an upper limit (for example, 16 KB) on the amount of data that can be copied. The copy processing is performed repeatedly in accordance with the size of the data to be copied.

When all the data 321 in the device-A 320 has been copied to the local store (LS) of the sub-processor element (SPE) 312, the MFC processing is determined to have been completed in step S303. As shown in FIG. 6, the data 315 is stored into the local store (LS) of the sub-processor element (SPE) 312. This is data 331 shown in FIG. 6. This copy processing is performed as data copy processing (MFC PUT) by the MFC of the sub-processor element (SPE) 312.

In the data copy processing by the MFC, one-time data copy processing by the MFC has also an upper limit (for example, 16 KB) on the amount of data that can be copied. Thus, the copy processing is performed repeatedly in accordance with the size of the data to be copied.

When all the data 315 stored in the local store (LS) has been copied to the local memory area of the device-B 330, the MFC processing is determined to have been completed in step S305. As shown in FIG. 6, the data 331 is stored into the device-B 330.

Finally, in step S306, the device-B 330 obtains the data 331, and performs data processing. For example, if the device-B 330 is a communication device, processing such as data transmission is performed.

In this manner, in the present embodiment, the following processing is performed in order to store data held by a device into another device.

(1) Execution of direct memory access (DMA) by the MFC of the sub-processor elements (SPE), that is to say, execution of MFC GET.

By this processing, data in the first device is copied to the local store (LS) of the sub-processor element (SPE).

(2) Execution of direct memory access (DMA) by the MFC of the sub-processor elements (SPE), that is to say, execution of MFC GET.

By this processing, the data in the local store (LS) of the sub-processor element (SPE) is copied to the second device.

By performing the processing sequence, data copy between devices is achieved without an occurrence of processing load on the main processor, PPE.

The present invention has been explained in detail by referring to the specific embodiments. However, it is obvious that those skilled in the art can perform modifications and substitutions on the embodiments without departing from the spirit of the present invention. That is to say, the present invention has been disclosed in a form of an example, and should not be limitedly interpreted. In order to determine the gist of the present invention, the appended claims should be taken into account.

Also, the series of processing described in the specification can be executed by hardware or by software or by the combination of both of these. When the processing is executed by software, the programs recording the processing sequence may be installed in a memory of a computer built in dedicated hardware. Alternatively, the various programs may be installed and executed in a general-purpose computer capable of executing various kinds of processing. For example, the programs may be recorded in a recording medium in advance. In addition to installation from a recording medium to a computer, the programs may be received through a network, such as a LAN (Local Area Network) and the Internet, and may be installed in a recording medium, such as an internal hard disk, etc.

In this regard, the various kinds of processing described in this specification may be executed not only in time series in accordance with the description, but also may be executed in parallel or individually in accordance with the processing ability of the apparatus executing the processing or as necessary. Also, a system in this specification is a logical set of a plurality of apparatuses, and is not limited to a set of constituent apparatuses that are contained in a same casing.

What is claimed is:

1. An information processing apparatus having a multi-processor unit including a plurality of processors,
the multi-processor unit comprising:
a main-processor element including a main processor; and
at least one sub-processor element having a sub-processor, a local memory corresponding to each of the processors, and a memory flow controller (MFC) executing data input from and data output to the local memory by DMA (Direct Memory Access),
wherein the memory flow controller (MFC) inputs data from the outside of the multi-processor unit, stores the data into the local memory by DMA processing, and further outputs the data stored in the local memory to an external memory of the multi-processor unit or a device by DMA processing.

2. The information processing apparatus according to claim 1, further comprising a system memory being bus-connected to the multi-processor unit,
wherein the system memory is a memory in which a kernel space managed by an operating system (OS) and a user space allowed to be used by an application are defined, and
the memory flow controller (MFC) inputs data from the kernel space of the system memory and stores the data into the local memory by DMA processing, and performs processing of outputting the data stored in the local memory to the user space of the system memory by DMA processing.

3. The information processing apparatus according to claim 1, further comprising: a first device and a second device which are bus-connected to the multi-processor unit,
wherein the memory flow controller (MFC) inputs data from the first device by DMA processing and stores the data into the local memory, and further outputs the data stored in the local memory to the second device by DMA processing.

4. The information processing apparatus according to claim 1,
wherein the sub-processor element having the memory flow controller (MFC) executing data transfer by the DMA processing is an element executing the operating system (OS).

5. The information processing apparatus according to claim 2,
wherein the data output to the user space through data transfer by the DMA processing is obtained and used by the application executed by any one of the plurality of sub-processor elements in the multi-processor unit.

6. A method of processing information for performing data transfer processing in an information processing apparatus,
the information processing apparatus having a multi-processor unit including a plurality of processors,
the multi-processor unit including:
a main-processor element including a main processor; and
at least one sub-processor element having a sub-processor, a local memory corresponding to each of the processors, and a memory flow controller (MFC) executing data input from and data output to the local memory by DMA (Direct Memory Access), the method comprising the steps of:
the memory flow controller (MFC) inputting data from the outside of the multi-processor unit, storing the data into the local memory by DMA processing, and
the memory flow controller (MFC) performing output processing of the data stored in the local memory to an external memory of the multi-processor unit or a device by DMA processing.

7. A computer program for causing an information processing apparatus to perform data transfer processing,
the information processing apparatus having a multi-processor unit including a plurality of processors,
the multi-processor unit including:
a main-processor element including a main processor; and
at least one sub-processor element having a sub-processor, a local memory corresponding to each of the processors, and a memory flow controller (MFC) executing data input from and data output to the local memory by DMA (Direct Memory Access), the method comprising the steps of:
the memory flow controller (MFC) inputting data from the outside of the multi-processor unit, storing the data into the local memory by DMA processing, and
the memory flow controller (MFC) performing output processing of the data stored in the local memory to an external memory of the multi-processor unit or a device by DMA processing.
